(19) United States
(12) Patent Application Publication
(10) Pub. No.: US 2019/0080354 A1
(43) Pub. Date: Mar. 14, 2019

(54) LOCATION PREDICTION BASED ON TAG DATA

(71) Applicant: Estia, Inc., San Antonio, TX (US)

(72) Inventors: Austin Avery Booker, San Antonio, TX (US); Nakul Jeirath, San Antonio, TX (US); Estefan Miguel Ortiz, San Antonio, TX (US); Augustine Vidal Pedraza, IV, San Antonio, TX (US)

(21) Appl. No.: 16/111,731

(22) Filed: Aug. 24, 2018

Related U.S. Application Data
(60) Provisional application No. 62/555,763, filed on Sep. 8, 2017.

(51) Int. Cl. G06Q 30/02; G06Q 50/00; G06N 99/00

(52) U.S. Cl. CPC G06Q 30/0261; G06N 99/005; G06Q 50/01

(57) ABSTRACT

Techniques are described for predicting location information and/or other characteristics of an author of item(s) published on a network, based on one or more tags (e.g., hashtags) that are included in the published item(s). Published items that are geotagged with location information are used to train, using machine learning techniques, a model that predicts the location of the author of non-geotagged item(s) based on the tag(s) included in the non-geotagged item(s). Model(s) may also be trained to predict other characteristics of authors of items. Implementations predict the location, and/or other characteristics, of individuals on networks (e.g., social networks) in instances where location and/or other characteristics are not otherwise known, thus enabling more effective targeting of individuals for marketing, advertising campaigns, and/or other types of influence application that may be performed on the network.

### CROSS-REFERENCE TO RELATED APPLICATION

The present disclosure is related to, and claims priority to, U.S. Provisional Patent Application Ser. No. 62/555,763, titled “Location Prediction Based On Tag Data,” which was filed on Sep. 8, 2017, and the entirety of which is incorporated by reference into the present disclosure.

### BACKGROUND

As the amount of information published on social networks has increased, organizations have developed various channels that attempt to use information published online to promote brands or other topics. Traditional marketing or advertising techniques have employed a generally unfocused approach in which information is indiscriminately targeted at a large population of individuals. Given their unfocused nature, such efforts may fail to effectively promote a topic (e.g., brand) or reach new audiences, leading to a diminished return on investment in marketing or advertising campaigns. Accurate targeting of marketing efforts may be further hindered by a lack of accurate information regarding individuals who post on social networks.

### SUMMARY

Implementations of the present disclosure are generally directed to the use of machine learning trained models to predict location and/or other types of demographic information regarding network publications, based on tags and/or other information included in the publication. More particularly, implementations of the present disclosure are directed to developing model(s) to correlate location and/or other demographic information with tags (e.g., hashtags) included in social network publications, and using the model(s) to predict, based on included tags in a publication, location and/or other demographic information regarding an individual who composed the publication. Although examples herein describe location prediction based on tags, such as hashtags, implementations are not so limited. Implementations can also operate to predict other types of demographic information, in addition to location, and/or other types of information regarding the users who publish items and/or regarding the items themselves. Implementations also can be used to make predictions based on other information regarding the published items, in addition to or instead of prediction based on tags.

In general, implementations of innovative aspects of the subject matter described in this specification can be embodied in methods that include actions of: receiving a training set of published items that are published on at least one network, wherein each of the training set of published items includes: a geotag indicating a location of an author of a respective published item, and at least one other tag; generating, based on the training set of published items, a model that predicts the location of the author of a published item based on the at least one other tag included in the published item; and applying the model to determine a predicted location of the author of at least one input published item that does not include a geotag.

These and other implementations can each optionally include one or more of the following innovative aspects: the at least one other tag is added to the respective published item by the author of the respective published item; the at least one other tag includes a hashtag; the predicted location is determined for at least one level of specificity within a hierarchy of location description levels of specificity; the actions further include filtering the training set of published items prior to generating the model, wherein the filtering includes removing the at least one of the training set for which the at least one other tag exhibits an occurrence frequency that exceeds a high-frequency threshold value or is below a low-frequency threshold value; the actions further include pre-processing the training set of published items prior to generating the model, wherein the pre-processing includes decomposing the at least one other tag to determine multiple words within the at least one other tag; the decomposing employs at least one dictionary; the model further provides a confidence level for the predicted location; the actions further include determining a second training set that includes the at least one input published item for which the confidence level is below a threshold value; the actions further include retraining the model based on the second training set; the at least one network includes a social network; and/or the published items are published as one or more of a tweet, a post, a share, or a comment on the social network.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following technical advantages and improvements over traditional systems. By providing a platform that predicts location and/or other characteristics of the authors of items published on a network, implementations enable more accurate targeting of individuals for advertising or marketing campaigns through the networks. Accordingly, implementations avoid the unnecessary expenditure of processing power, memory, storage space, network bandwidth, and/or other computing resources that traditional systems may expend through inaccurate targeting and/or iterative attempts at manually targeting individuals. The more accurate targeting provided by implementations helps reduce costs for consumers of the predictions (e.g., marketers, advertisers, etc.) by allowing them to focus on their desired target groups more narrowly, and by allowing them to tailor their message to the target group rather than simply broadcasting a general message to everyone, thus making their message more effective. Implementations also provide consumers with insight into the makeup of their audience to a level of detail that is not provided by previously available solutions.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for predicting location and/or other characteristics for items published in a network, according to implementations of the present disclosure.

FIG. 2A depicts an example process for developing predictive model(s), according to implementations of the present disclosure.

FIG. 2B depicts an example process for using model(s) to generate prediction(s), according to implementations of the present disclosure.

FIG. 3A depicts an example of item tags used for generating a model, according to implementations of the present disclosure.

FIG. 3B depicts an example of generating predictions for an example item, according to implementations of the present disclosure.

FIG. 4 depicts a flow diagram of an example process for model generation, according to implementations of the present disclosure.

FIG. 5 depicts a flow diagram of an example process for generating prediction(s), according to implementations of the present disclosure.

FIG. 6 depicts an example computing system, according to implementations of the present disclosure.

### DETAILED DESCRIPTION

Implementations of the present disclosure are directed to systems, devices, methods, and computer-readable media for predicting location information and/or other characteristics of an author of item(s) published on a network, based on one or more tags (e.g., hashtags) that are included in the published item(s). A set of published items that are geotagged with location information, and that also include other tag(s), are analyzed to train, using machine learning techniques, a model that predicts the location of the author of non-geotagged item(s) based on the tag(s) included in the non-geotagged item(s). Model(s) may also be trained to predict other characteristics of authors of items, including demographic characteristics such as age, gender, and so forth. Implementations predict the location, and/or other characteristics, of individuals on networks (e.g., social networks) in instances where location and/or other characteristics are not otherwise known, thus enabling more effective targeting of individuals for marketing, advertising campaigns, and/or other types of influence application that may be performed on the network.

Implementations provide an analysis platform in which published items are analyzed, using a machine learning-trained model, to infer demographic characteristics of the author(s) of the items. The inferred characteristics can include, but are not limited to, a location of the author and/or of the computing device used by the author to compose and submit the item for publication on a network. In an example social network, a proportion of posts, tweets, comments, and/or other types of items may be geotagged at the time when they are composed and/or published. A geotag may be metadata that indicates a location of the author (and/or the author's computing device) to any suitable degree of specificity. For example, a geotag may indicate location as one or more of a country, state, province, prefecture, county, city, neighborhood, street address, building, and so forth. In some instances, a geotag may indicate a particular event that the author is attending at the indicated location, such as a concert, festival, celebration, and so forth. In some instances, an item may be automatically geotagged by a computing device of the author and/or by the service that is publishing the item, based at least partly on location data received from the author's computing device. For example, the item may be geotagged with a location that is determined based on a satellite-based navigation system such as a version of the Global Positioning System (GPS). In some instances, the author may specify the geotag when they compose and/or submit the item for publication.

A proportion of items published to a network may be geotagged, either automatically and/or manually by the user(s) who published the item(s), and the remainder of items may be published without a geotag. For example, 10% of the items published on a network may be geotagged, and the other's may not be geotagged. The published items may also include other tags that are added by the author to the item. In some instances, the tags may include one or more control characters that designate the subsequent, preceding, or otherwise proximal text as a metadata tag. For example, a tag may be designated with a starting character “#”. Such tags may be referred to as hashtags, such as those used on various social network and/or microblogging services. Other types of tags can also be analyzed by the platform described herein. The platform may use the geotagged items to generate a model based on a detected correlation between particular tags and geotags, in those items that are geotagged and that include other tag(s). One or more suitable machine learning techniques may be used to develop the model. The model is then used to predict a location of the author (and/or author's computing device) of those items that do not include a geotag and that do include other tag(s).

In some implementations, the model may be trained based on an input vector (e.g., a feature vector) that includes a frequency count of various tag(s) in published items. The model may be trained as a classifier that outputs a predicted location based on the tag(s) included in published items that are input to the model. Other information may also be predicted based on the item(s). For example, a model may be developed and used to predict demographic characteristics of item authors, such as gender, an age (or age range), an income (or income range), achieved education level, natural language(s) spoken, and so forth. Psychographic characteristics can also be predicted such as personality types, emotional attributes, interests, hobbies, and so forth.

In some implementations, locations and/or other characteristics are predicted based on tag(s) included in published items, such as hashtags. Other data from the published item(s) may also be employed, in addition to or instead of the tag(s). For example, a model may be developed to predict location and/or other characteristics based on text data, images, audio, video, and/or other types of data included in published items. Predictions may also be made based on various types of metadata included in, or otherwise associated with, the published items, such as a timestamp (e.g., date and/or time) of the composition and/or publication of the item, an identification of the computing device (or type of device) used to compose the item, the application (or app) used to compose the item, the particular network where the item is published, and so forth.

In some implementations, filtering and/or pre-processing may be performed on the input data set of published items that is used to train or otherwise generate the model(s). Filtering may include removing one or more items that include tags (e.g., outliers) that occur at a frequency that is lower than a predetermined threshold frequency value. Filtering may also include removing one or more items that include tags that occur at a frequency that is higher than a predetermined threshold frequency value. In some instances, certain high frequency-occurring tags may be used in such a wide variety of published items that they may be treated as background noise that would mask relevant correlations. For example, #throwbackthursday or #tbt may occur in published items at a high frequency, without any particular correlation to location or other author characteristics. Such tag(s), and/or the item(s) that include such tag(s), may be removed from the input data set that is used to train the model(s). The model(s) may be trained using a filtered and/or pre-processed data set that includes labeled items determined to be relevant to the prediction, e.g., determined to exhibit a likely correlation with location or some other characteristic to be predicted. In some implementations, tags may be filtered out and omitted from the analysis if the tags do not have any correlation to a particular location. For example, the tags #worldtraveler and #NotreDameIsHorrible (e.g., referring to the college and/or football team) are generally not associated with any particular geographic location so the process may filter those out as part of the pre-processing.

In some implementations, the generation of the model(s) may employ a training data set of published item that include tags that explicitly include location names in the tags, such as #SanAntonio, #Paris, #TheAlamo, or #TheLouvre. The model(s) may also be trained using other types of tags that are not explicitly indicative of a particular location. The model(s) may be trained using a training set of published items that include a single tag or multiple tags. In some instances, the model may more accurately prediction location or other characteristics based on multiple tagged items.

In some implementations, active learning or pool-based learning is employed to develop and/or refine the model(s). For example, a training data set including a number (e.g., 100) of geotagged or otherwise labeled items can be used to build a classifier. That classifier can then be used to determine what is the next best sample of items to label (e.g., geotag) and then to include in another data set for retraining and/or refining the model. In such instances, the model may be a classifier such as a maximum margin classifier, support vector machine (SVM), or other suitable classifier. Determining the set of items to include in the subsequent data set may include determining the set of items for which the confidence level of the previous classification (using the previous version of the model) is below a predetermined threshold confidence level. For example, in an N-dimensional vector space of the item tag vectors, a hyperplane may divide the space in half. The hyperplane may correspond to a minimum confidence level and/or a maximum uncertainty in the classification. Unlabeled samples (e.g., items) to be classified may be examined to determine their (e.g., Euclidean) distance from the dividing hyperplane. Items that are within a threshold distance of the hyperplane may be selected and added to the training set that is used to retrain the classifier in the next iteration. This process may be repeated for any suitable number of iterations to refine the model using those items that exhibit maximum uncertainty in classification. In some implementations, multi-layered neural networks may be employed. If the output confidence level is at or near 50% confidence, indicating maximum uncertainty whether the classification is correct or incorrect, such items may be included in the unlabeled set used to train the next version of the model. In either example, the model is retrained based on the items (e.g., close cases) that exhibit maximum, or near-maximum, uncertainty in their classification as indicated by the probability output of classification results from a previous iteration using a previous version of the classifier. Such close cases can be (e.g., manually) labeled with a geotag or other label, and used as a retraining data set to refine the classifier.

In some instances, tags may fall within certain permutation groups. For example, tags may include #LasVegas, #Vegas, #LasVegasNevada, and so forth. In some implementations, the tags within a permutation group may be treated as a same tag for generating the model and/or for using the model to make predictions. The pre-processing may include normalizing the different tags in a permutation group to be the same tag, such as changing #Vegas to #LasVegas wherever it appears in the analyzed published items. The distance (e.g., similarity) between tags may be analyzed to determine a distance between the tags in the N-dimensional tag space, and preprocessing may include performing a clustering algorithm to determine the groups as clusters that exhibit higher-than-threshold level similarity with respect to the words and/or characters in the tags. Such clustering may be described as modeling the density of the feature vector (e.g., tag) space, and density of the features may be measured using a distance metric such as the Kullback-Leibler divergence measure.

In some implementations, dictionaries are derived to assist with tag decomposition, such as to determine instances in which a tag includes multiple words and to determine where the division between words occurs in a tag. Decomposition may involve imposing a grammar onto the tags by determining separation between words. A dictionary may provide a mapping between a multi-word tag and a multi-word phrase with separated words. For example, a tag #LasVegasNevada may be mapped to a decomposed phrase “Las Vegas Nevada.” The dictionary may be used in a pre-processing phase to decompose tags into component words prior to training the model(s) and/or using the model(s) to make predictions. Implementations may also employ other techniques for accomplishing the decomposition in addition to or instead of the use of dictionaries.

Networks and/or groups of tags that tend to co-occur in particular items may also be identified. For example, items that include the tag #Alamo may also have a high probability of including the tag #TheAlamo, and the two tags (and/or other co-occurring tags) may be determined as a network or group. Such networks and/or groups may be treated as a group or as the same tag in the modeling and prediction analysis.

In some implementations, the (e.g., geotagged) published items that are used to develop the model(s), and the (e.g., non-geotagged) published items that are input to the model(s) for prediction of location or other characteristics, include posts, comments, reviews, or other content published on a network such as a social network. In some implementations, the geotagged published item data is retrieved from the network(s) in real time as the item(s) are published and/or become available, and used to develop the model(s). In some implementations, real-time data extraction and analysis modules (e.g., such as the data collection module(s) described below) may respond to newly available geotagged published item data by analyzing the data and updating (e.g., retraining) the predictive model(s) as needed. Alternatively, geotagged published item data may be collected over a period of time (e.g., a day, a week, a month, etc.), and analyzed in a batch to train and/or retrain the model(s). In some implementations, the application of the model(s) to non-geotagged published item(s), to predict location and/or other characteristics, may be performed in real time with respect to publication and/or availability of the published item(s) on the network(s). Alternatively, the prediction(s) may be generated at some time that is not in real time with respect to item publication.

As used herein, a real time operation may describe an operation that is performed based on triggering event and without any intentional delay between the performed operation and the triggering event, taking into account the processing and/or communication limitations of the computing system(s) performing the operation and the time needed to initiate and/or perform the operation. The triggering event may be a received communication, a detection of a particular application state, another operation performed by the same or a different process, and so forth. A real time operation may also be described as a dynamic operation. Real time operations may include operations that are automatically executed in response to the triggering event without requiring human input or some other intervening action. In some examples, a real time operation may be performed within a same execution path as a process that detects and/or handles the triggering event. For example, the real time operation may be performed or initiated by code that executes as part of the handling of the event and/or in response to a message that is sent as part of the handling of the event. A real time operation may, in at least some instances, be performed synchronously with respect to the triggering event. In some implementations, the training and/or retraining of a model may be performed in real time with respect to the publication of (e.g., geotagged) item(s) on a network and/or retrieval of published item(s) from a network. In some implementations, the prediction(s) described herein may be performed in real time with respect to the publication of (e.g., non-geotagged) item(s) on a network and/or retrieval of published item(s) from a network.

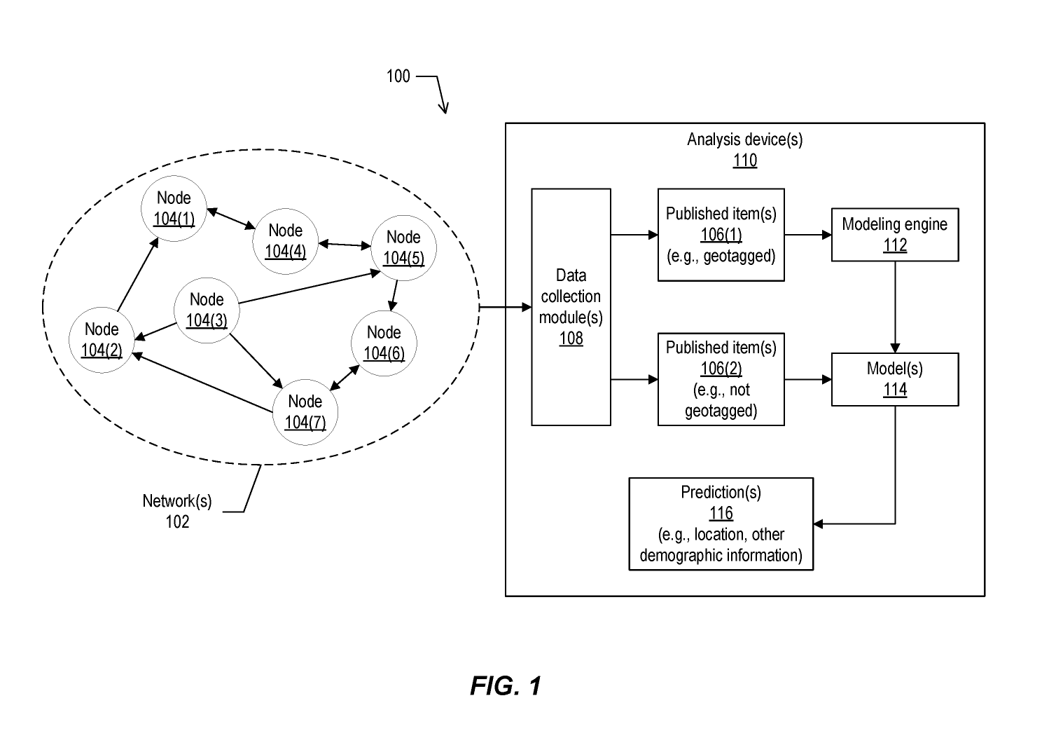

FIG. 1 depicts an example system 100 for predicting location and/or other characteristics for published items in a network, according to implementations of the present disclosure. As shown in the example of FIG. 1, the environment may include one or more networks 102. The network may include any number of nodes 104 that are able to communicate with one another through the network 102. In some instances, a node 104 may be a user of the network 102. A network 102 may include any type of network in which user(s) may publish item(s) to be viewed by other user(s). In some instances, the published item(s) may be republished by the user(s) on the network, and/or published to other network(s). In some instances, a network 102 may be a social network in which users communicate with other users via published items. A network 102 may include users who have registered with the network 102, such that the users have accounts, profiles, or other forms of presence in the network 102. Examples of a network 102 may include Facebook™, Twitter™, Instagram™, Pinterest™, Weibo™, WeChat™, Alibaba™, or others. A network 102 may be public, such that any user may be allowed to publish, view, and republish items. A network 102 may be, to some extent, private, such that a subset of the general public is allowed to publish, view, and republish items.

A user may publish item(s) 106 that may be viewable and/or republishable by other user(s) in the same network 102 and/or other network(s). A network 102 may employ any data suitable format or arrangement of data for published items 106, and published items 106 may be communicated within the network 102 using any suitable communication protocol. A published item may include one or more types of data, including but not limited to text data, graphics, images, videos, audio data, and so forth. The publishing user may be associated with a set of followers, e.g., other user(s) in the network 102. A follower of a publishing user may include a user who has indicated a desired to view published item(s) 106 of the publishing user 104. For example, a follower may edit their user profile or account information to follow the publishing user, and subsequently the follower may receive notifications indicating when the publishing user publishes an item 106. A follower may be variously described in different social networks as a follower, a friend, a contact, a link, a fan, and so forth.

The followers of the publishing user 104 may also republish the original published item(s) 106 of the publishing user. Republication may include, but is not limited to, sharing, reposting, retweeting, or commenting on the published item 106, such that the published item 106 may then be viewed by other users. Republication may include republication of the published item 106 in its entirety, or republication of any portion of the published item 106 (e.g., as an excerpt). A follower of the publishing user may republish an item 106 such that the item 106 is viewable by other users who are followers of the republishing user. Any number of those followers may then republish the item 106 to be viewable by other, who may themselves republish the item 106, and so on to any number of republication levels. In this way, a published item 106 may propagate through a network 102. Each set of republications by one or more republishing users may be described as a ripple of the published item 106 as it propagates within the network 102.

Although examples herein may describe users viewing an item that is published in a network 102, implementations are not limited to item(s) 106 that are visually presented to users. An item 106 may also be presented, at least in part, as audio data, haptic data (e.g., vibrations or other movements of a computing device), or via other modes of presentation.

As shown in the example of FIG. 1, the environment may include one or more analysis computing devices 110, which may include any suitable number and type of computing device. The analysis computing device(s) 110 may be described as a platform for predicting location and/or other characteristics for published items. The analysis computing device(s) 110 may execute any suitable number of software module(s), which may be described as an engine for making predictions.

The analysis computing device(s) 110 may execute one or more data collection module(s) 108 which collect information regarding one or more network(s) 102. The data collection module(s) 108 may retrieve and store one or more published item(s) 106 published on the network(s) 102. The data collection module(s) 108 may also retrieve metadata describing the published item(s) 106, including but not limited to a timestamp (e.g., date and/or time) of publication, the publishing user, a subject line, title, or summary of the item 106 as published, a category of the item 106, and/or other metadata such as tags, hashtags, and so forth. The data collection module(s) 108 may also retrieve and store other information available in the network(s) 102, such as demographic information regarding the user(s) who publish item(s) 106, where such demographic information is available. Demographic information may include various user characteristics, including but is not limited to one or more of the following: user location (e.g., to any degree of specificity), age, gender, ethnic identification, spoken language(s), profession, hobbies, interests, income level, purchase history, group affiliation(s), education level, or other characteristics.

A first set of unlabeled (e.g., geotagged) published items 106(1) may be provided to a modeling engine 112, which generates one or more predictive model(s) 114. In some implementations, the model(s) 114 are employed to predict location of the author of input published item(s) 106(2) that are not geotagged. In some implementations, the model(s) 114 are generated to predict other characteristic(s) of the item author(s). For example, the model(s) 114 may predict demographic characteristics of the item author(s). In such instances, the model(s) 114 may be trained or otherwise developed using labeled data that is labeled according to the corresponding demographic information that may be collected by the data collection module(s) 108 as described above.

The prediction(s) 116 that are output from the model(s) 114 may be stored and/or provided to various consumers, such as individuals interested in the predicted location or other characteristic information. Employing the predictions 116 made for location and/or other characteristics may enable consumers such as marketers, advertisers, and/or others to create campaigns that target particular individuals on network(s) with greater precision, and that are therefore more effective at spreading information than traditional campaigns which may indiscriminately broadcast information within the network(s) 102. A more focused, better targeted campaign can potentially provide a higher return on investment for marketing or advertising expenditures.

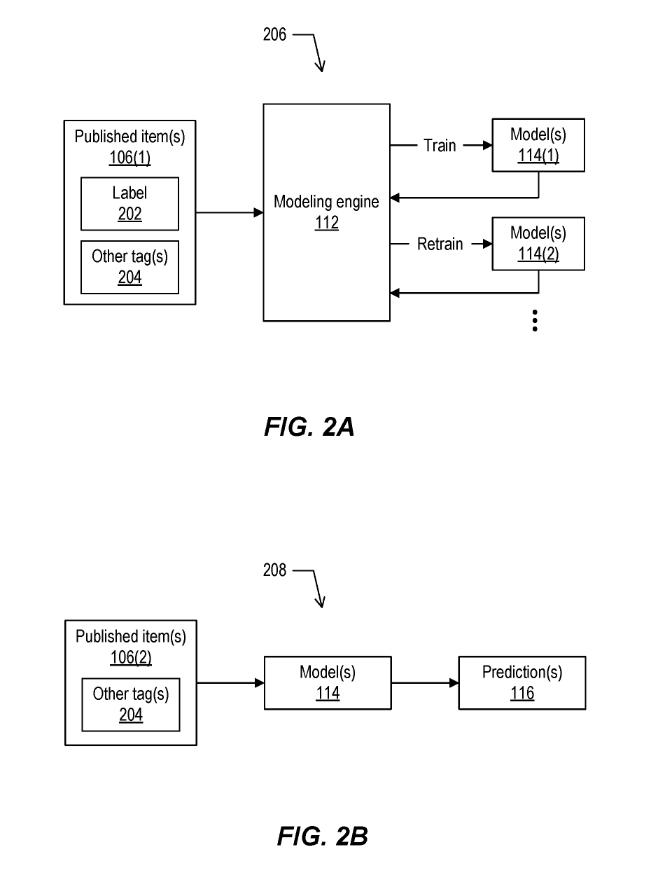

FIG. 2A depicts an example process 206 for developing predictive model(s), according to implementations of the present disclosure. As shown in this example, the published item(s) 106(1) may be a training data set that is used by the modeling engine 112 to generate model(s) 114. Each of the item(s) 106(1) in the training data set may include a label 202 that is relevant to the particular attribute that the model(s) 114 are being trained to predict. For example, the label 202 may be a geotag that indicates a location of the author of the respective item, and/or a location of the computing device used to compose the item. Each item 106(1) may also include one or more other tags 204. The modeling engine 112 may operate to generate a first version of the model(s) 114(1), which may then be refined, retrained, and/or otherwise updated in any suitable number of iterations to generate updated versions of the model(s) 114(2).

FIG. 2B depicts an example process 208 for using model(s) to generate prediction(s), according to implementations of the present disclosure. As shown in this example, an input item 106(2) may include the other tag(s) 204 but may not include the label 202 such as a geotag. Such unlabeled item(s) 106(2) may be provided as input to the model(s) 114, which may generate prediction(s) 116 for location and/or other characteristics based on the tag(s) 204 and/or other information in the item(s) 106(2).

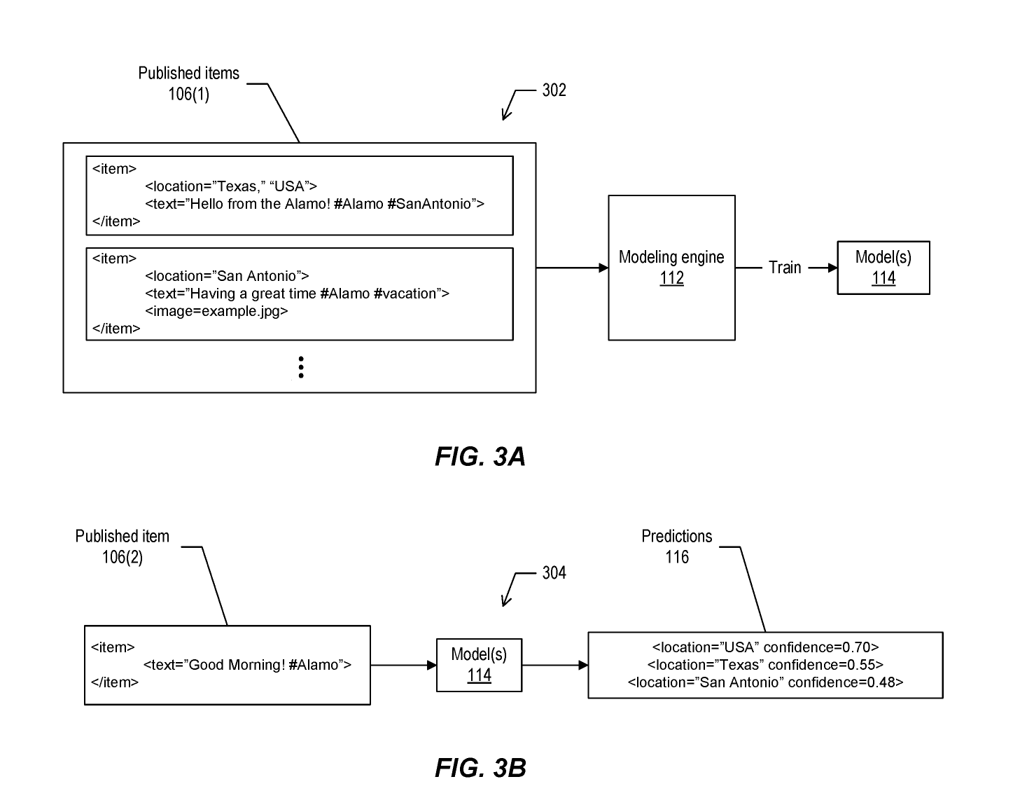

FIG. 3A depicts an example 302 of using item tags for generating a model, according to implementations of the present disclosure. In this example, the training set includes item(s) 106(1) that have labels that are geotags indicating location to varying degrees of specificity. The item(s) 106(1) also include other types of tags (e.g., “#Alamo,” “#vacation,” etc.). Such labeled data is provided to the modeling engine 112, which trains or otherwise generates the model(s) 114 used to predict location based on tags.

FIG. 3B depicts an example 304 of generating predictions for an example item, according to implementations of the present disclosure. In this example, an unlabeled (e.g., non-geotagged) item 106(2) is provided to the model 114, such as a model 114 trained in FIG. 3A. The model 114 outputs various predictions 116 of location based on the tag(s) 204 included in the item 106(2). As shown in this example, the model 114 can output various predictions of location at varying degrees of specificity, and each prediction may be provided with a confidence metric that indicates a predicted accuracy of the prediction generated by the model 114. In this example, the model 114 has generated location predictions for the country, state, and city of the author of the item 106(2), predicted based on the included tag “#Alamo.” A confidence level is provided for each prediction.

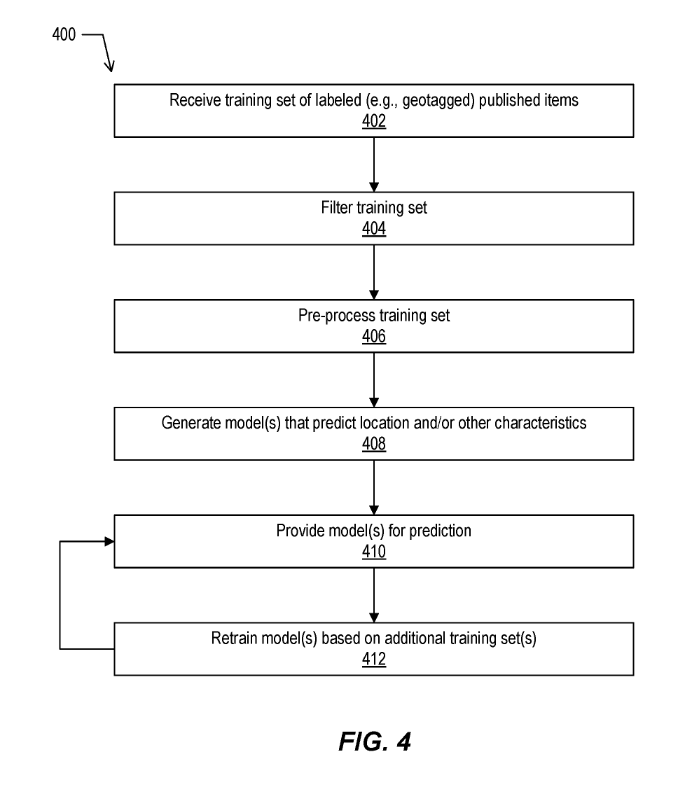

FIG. 4 depicts a flow diagram 400 of an example process for model generation, according to implementations of the present disclosure. Operations of the process can be performed by one or more of the data collection module(s) 108, the modeling engine 112, and/or other software executing on the analysis device(s) 110 or elsewhere.

A training set of labeled (e.g., geotagged) published items is received (402). In some implementations, the training set may be filtered (404) and/or otherwise pre-processed (406) as described above, prior to further analysis. The training set (e.g., in some instances filtered and/or pre-processed) is used to generate (408) model(s) that predict location and/or other (e.g., demographic) characteristics. The model(s) are provided (410) for use in generating predictions. The model(s) may be retrained (412) to provide more accurate predictions. Retraining may proceed as described above and/or through the use of training set(s) that include more recent published items.

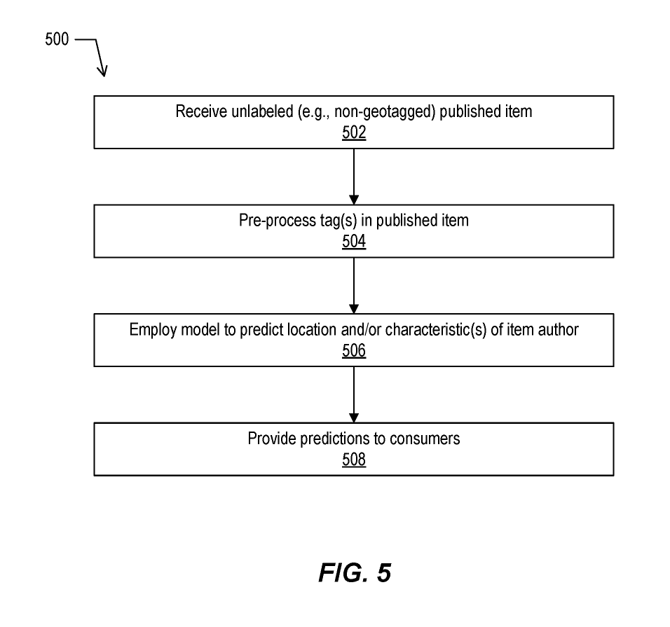

FIG. 5 depicts a flow diagram 500 of an example process for generating prediction(s), according to implementations of the present disclosure. Operations of the process can be performed by one or more of the data collection module(s) 108, the modeling engine 112, and/or other software executing on the analysis device(s) 110 or elsewhere.

An unlabeled (e.g., non-geotagged) published item is received (502). In some implementations, the item may be pre-processed as described above. The item may be provided to a model, and the model may be employed (506) to prediction location and/or other characteristics of the author of the item, based at least partly on the other tags included in the item (e.g., other than the geotag or other label). The predictions are provided (508) to consumers and/or stored for future use.

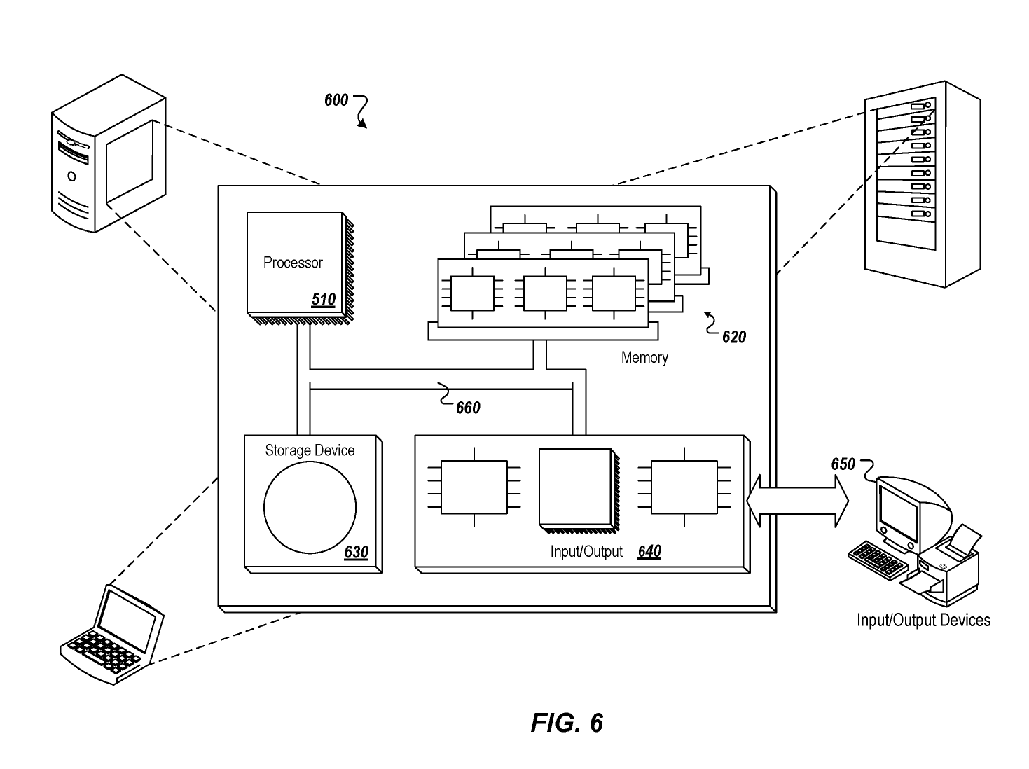

FIG. 6 depicts an example computing system 600, according to implementations of the present disclosure. The system 600 may be used for any of the operations described with respect to the various implementations discussed herein. For example, the system 600 may be included, at least in part, in the analysis computing device(s) 110, and/or other computing device(s) or system(s) described herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices such as a display, LED(s), an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method performed by at least one processor, the method comprising:
receiving, by the at least one processor, a training set of published items that are published on at least one network, wherein each of the training set of published items includes: a geotag indicating a location of an author of a respective published item, and at least one other tag;
generating, by the at least one processor, based on the training set of published items, a model that predicts the location of the author of a published item based on the at least one other tag included in the published item; and
applying, by the at least one processor, the model to determine a predicted location of the author of at least one input published item that does not include a geotag.

2. The method of claim 1, wherein the at least one other tag is added to the respective published item by the author of the respective published item.

3. The method of claim 1, wherein the at least one other tag includes a hashtag.

4. The method of claim 1, wherein the predicted location is determined for at least one level of specificity within a hierarchy of location description levels of specificity.

5. The method of claim 1, further comprising:
filtering, by the at least one processor, the training set of published items prior to generating the model, wherein the filtering includes removing the at least one of the training set for which the at least one other tag exhibits an occurrence frequency that exceeds a high-frequency threshold value or is below a low-frequency threshold value.

6. The method of claim 1, further comprising:
pre-processing, by the at least one processor, the training set of published items prior to generating the model, wherein the pre-processing includes decomposing the at least one other tag to determine multiple words within the at least one other tag.

7. The method of claim 6, wherein the decomposing employs at least one dictionary.

8. The method of claim 1, wherein the model further provides a confidence level for the predicted location.

9. The method of claim 8, further comprising:
determining, by the at least one processor, a second training set that includes the at least one input published item for which the confidence level is below a threshold value; and
retraining, by the at least one processor, the model based on the second training set.

10. The method of claim 1, wherein:
the at least one network includes a social network; and
the published items are published as one or more of a tweet, a post, a share, or a comment on the social network.

11. A system, comprising:
at least one processor; and
a memory communicatively coupled to the at least one processor, the memory storing instructions which, when executed by the at least one processor, cause the at least one processor to perform operations comprising:
receiving a training set of published items that are published on at least one network, wherein each of the training set of published items includes: a geotag indicating a location of an author of a respective published item, and at least one other tag;
generating, based on the training set of published items, a model that predicts the location of the author of a published item based on the at least one other tag included in the published item; and
applying the model to determine a predicted location of the author of at least one input published item that does not include a geotag.

12. The system of claim 11, wherein the at least one other tag is added to the respective published item by the author of the respective published item.

13. The system of claim 11, wherein the at least one other tag includes a hashtag.

14. The system of claim 11, wherein the predicted location is determined for at least one level of specificity within a hierarchy of location description levels of specificity.

15. The system of claim 11, the operations further comprising:
filtering the training set of published items prior to generating the model, wherein the filtering includes removing the at least one of the training set for which the at least one other tag exhibits an occurrence frequency that exceeds a high-frequency threshold value or is below a low-frequency threshold value.

16. The system of claim 11, the operations further comprising:
pre-processing the training set of published items prior to generating the model, wherein the pre-processing includes decomposing the at least one other tag to determine multiple words within the at least one other tag.

17. The system of claim 16, wherein the decomposing employs at least one dictionary.

18. The system of claim 11, wherein the model further provides a confidence level for the predicted location.

19. The system of claim 18, the operations further comprising:
determining a second training set that includes the at least one input published item for which the confidence level is below a threshold value; and
retraining the model based on the second training set.

20. One or more computer-readable media storing instructions which, when executed by at least one processor, cause the at least one processor to perform operations comprising:
receiving a training set of published items that are published on at least one network, wherein each of the training set of published items includes: a geotag indicating a location of an author of a respective published item, and at least one other tag;
generating, based on the training set of published items, a model that predicts the location of the author of a published item based on the at least one other tag included in the published item; and
applying the model to determine a predicted location of the author of at least one input published item that does not include a geotag.
